(19) United States
(12) Patent Application Publication
(10) Pub. No.: US 2026/0248149 A1
(43) Pub. Date: Aug. 27, 2026

(54) METHOD OF PREVENTING AND/OR INHIBITING THE OUTGROWTH, SPORULATION, GERMINATION OR TOXIN FORMATION OF CLOSTRIDIUM

(71) Applicant: GIVAUDAN SA, VERNIER (CH)

(72) Inventors: Mélanie Marie-Paule Patricia HEUDRE, Avignon (FR); Amelie ROUGER, Avignon (FR)

(21) Appl. No.: 18/860,257

(22) PCT Filed: Apr. 20, 2023
(86) PCT No.: PCT/EP2023/060232

§ 371 Date: Oct. 25, 2024

(30) Foreign Application Priority Data
May 5, 2022 (GB) 2206571.8
May 5, 2022 (GB) 2206599.9

(51) Int. Cl. A23B 4/20; A23B 2/733; A23B 2/754; A23B 2/771; A23B 4/12

(52) U.S. Cl. CPC A23B 4/20; A23B 2/733; A23B 2/754; A23B 2/771; A23B 4/12

(57) ABSTRACT

The present invention is related to a method of preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of toxins of Clostridium in a product, comprising adding to the product, comprising adding to the product a Lamiaceae extract, ascorbic acid and/or acetic acid.

Different food spoiler bacteria form spores that are a problem for the Food industry.

For example, the three predominant species of heat-resistant microorganisms that are isolated in low-acid canned foods are Geobacillus stearothermophilus, Moorella thermoacetica and Thermoanaerobacterium spp.

Moreover, Clostridum not only form spores but also produces toxins. Clostridium forms spores particularly resistant to heat and disinfectants, grows in, for instance, food, at 3-40° C., pH 4.5, without oxygen, in the presence of water and nutrients, and produces toxins. In the case of Clostridium botulinum, the latent period of the bacteria is 12-36 hours, but the toxin produced is a potential neurotoxin that, if ingested, causes exhaustion, dizziness, and gastrointestinal symptoms such as nausea and vomiting, which then gradually leads to nervous disorders such as headache, visual impairment, difficulty in swallowing, and difficulty in walking, and if serious, eventually leads to dyspnea and results in death.

Food poisoning is dreaded especially among food-processing businesses, and various methods of sterilization and disinfection are being studied and implemented. However, as described above, Clostridium botulinum loses its toxicity only after a long period of treatment at high-temperature, which may not be applicable for some types of food. Further, Clostridium botulinum prefers anaerobic conditions found in preserved foods such as bottled and canned preserves, making its prevention even more difficult.

Clostridium perfringens also produce a wide range of symptoms, from food poisoning to gas gangrene and is a problem for the food industry.

Curing agents such as salts of sodium nitrate and sodium nitrite have a long history of preserving the microbial safety of processed meat formulations against Clostridium contaminations.

However, an increasing number of consumers believe foods that are free of synthetic or chemical additives are healthier and new natural solutions free of sodium nitrate and sodium nitrite that provide a protection against Clostridium contaminations and Clostridium toxins are still needed.

JP6101193 B2 describes a bacteriostatic agent for a spore-forming bacterium (including the bacterium in spore state) having a fatty acid monoglyceride consisting monoglyceride palmitate and/or monoglyceride stearate, as an active ingredient

JP5048011 B2 describes a citric acid as an active ingredient that inhibit the spore germination in vegetable beverages wherein the citric acid it is added to the product so that the pH of the vegetable beverage is between 4.2 and 4.6. A spore germination and growth inhibitor.

However, those solutions do not have an effect against the toxin production.

U.S. Ser. No. 10/327,463 B2 describes a method using an antimicrobial composition to control the outgrowth of pathogens and spoilage microorganisms in food and beverage products, comprising the steps of: providing a food or beverage product having a moisture content of about 38% by weight to about 80% by weight, pH in the range of about 4.6 to about 8.5, and salt content less than about 5.0% by weight; contacting the food or beverage product with the antimicrobial composition comprising acetic acid or its salt and a fermentation derived antimicrobial peptide to control growth of pathogens and growth of spoilage microorganisms, wherein the acetic acid or its salt has a concentration in the food or beverage product of at least 0.275% by weight; and packaging the food or beverage product.

However further solutions that increase the shelf life without the use of Nitrites are needed.

Therefore, in a first aspect, the present invention provides a method of preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of toxins of Clostridium in a product, comprising adding to the product a Lamiaceae extract, ascorbic acid and/or acetic acid.

The present invention is also directed to a method of preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of toxins of Clostridium in a product, comprising adding to the product at least one phenolic diterpene, ascorbic acid and/or acetic acid.

The present invention is also directed to a method of preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of toxins of Clostridium in a product, comprising adding to the product a composition comprising a Lamiaceae extract, ascorbic acid and/or acetic acid (first composition of the invention).

The present invention is also directed to a method of preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of toxins of Clostridium in a product, comprising adding to the product a composition comprising at least one phenolic diterpene, ascorbic acid and/or acetic acid (second composition of the invention).

It is also object of the invention a method of preventing and/or inhibiting the outgrowth and/or of preventing and/or inhibiting the germination of spores of a spore forming bacteria selected from Geobacillus, the genus Morpherella (Moorella), the genus Thermoanaerobacter (Thermoanaerobacter), the genus Thermoanaerobacterium and/or the genus Alicyclobacillus; in a product, comprising adding to the product a composition of the invention (a first or a second composition of the invention).

It is also object of the invention a method of preventing and/or inhibiting the outgrowth and/or of preventing and/or inhibiting the germination of spores of a spore forming bacteria selected from Geobacillus, the genus Morpherella (Moorella), the genus Thermoanaerobacter (Thermoanaerobacter), the genus Thermoanaerobacterium and/or the genus Alicyclobacillus; in a product, comprising adding to the product a Lamiaceae extract, ascorbic acid and/or acetic acid.

It is also object of the invention a method of preventing and/or inhibiting the outgrowth and/or of preventing and/or inhibiting the germination of spores of a spore forming bacteria selected from Geobacillus, the genus Morpherella (Moorella), the genus Thermoanaerobacter (Thermoanaerobacter), the genus Thermoanaerobacterium and/or the genus Alicyclobacillus; in a product, comprising adding to the product at least one phenolic diterpene, ascorbic acid and/or acetic acid.

In certain preferred embodiments, the products are packaged products.

The invention and its preferred features will be described in more detail below.

For the avoidance of doubt, preferences, options, particular features and the like indicated for a given aspect, feature or parameter of the invention should, unless the context indicates otherwise, be regarded as having been disclosed in combination with any and all other preferences, options, particular features and the like as indicated for the same or other aspects, features and parameters of the invention.

The terms “comprises,” “comprising,” “has,” “having,” “includes,” “including,” “contains,” “containing,” or any other variation are open-ended and are intended to cover a non-exclusive inclusion of elements, such that an article, apparatus, compound, composition, combination, method, or process that “comprises,” “has,” or “includes,” or “contains” a recited list of elements does not include only those elements but may include other elements not expressly listed, recited or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more unless expressly stated otherwise or constrained by other language herein. An element or feature proceeded by “a” or “an” may be interpreted as one of the recited element or feature, or more than one of the element or feature. For instance, a CGA may be interpreted as one chlorogenic acid or as more than one chlorogenic acids.

The terms “about,” “approximately,” “essentially,” “substantially,” any other version thereof, or any other similar relative term, or similar term of approximation, are defined as being close to as understood by one having ordinary skill in the art. By way of non-limiting, illustrative embodiments, these terms are defined to be within 20% of a recited value, or defined to be within 10% of a recited value, or defined to be within 5% of a recited value, or defined to be within 4% of a recited value, or defined to be within 3% of a recited value, or defined to be within 2% of a recited value, or defined to be within 1% of a recited value, or defined to be within 0.5% of a recited value, or defined to be within 0.25% of a recited value, or defined to be within 0.1% of a recited value.

It should be understood that when an amount in weight percent is described in the present disclosure, it is intended that any and every amount within the range, including the end points, is to be considered as having been expressly disclosed. For example, the disclosure of “a range of from about 1 to about 10” is to be read as indicating each and every possible number along the continuum between about 1 and about 10. It is to be understood that the inventors appreciate and understand that any and all data points within the range are to be considered to have been specified, and that the inventors have possession of the entire range and all points within the range.

For the avoidance of doubt, preferences, options, particular features and the like indicated for a given aspect, feature or parameter of the invention should, unless the context indicates otherwise, be regarded as having been disclosed in combination with any and all other preferences, options, particular features and the like as indicated for the same or other aspects, features and parameters of the invention.

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

Preferred and/or optional features of the invention will now be set out. Any aspect of the invention may be combined with any other aspect of the invention unless the context demands otherwise. Any of the preferred or optional features of any aspect may be combined, singly or in combination, with any aspect of the invention, as well as with any other preferred or optional features, unless the context demands otherwise.

### Method

The invention stems, inter alia, from the unexpected finding by the inventors that the combination of a Lamiaceae extract, ascorbic acid and/or acetic acid can effectively alter the virulence of Clostridium bacteria, by inhibiting the production and release of toxins and the sporulation and spore germination of Clostridium, leading to an effective neutralization of the pathogenicity of these bacteria in food products.

Therefore, the invention provides an anti-Clostridium composition comprising at least a Lamiaceae extract and/or ascorbic acid and/or acetic acid and any mixtures thereof (first anti-Clostridium composition of the invention). Just by way of clarification, it is clearly understood that the first composition of the invention may comprise one, two or the three components in any kind of combinations of the components. For example, the first composition of the invention may comprise only ascorbic acid, only at least a Lamiaceae extract, or only acetic acid. For example, the composition may comprise ascorbic acid and acetic acid, or may comprise at least one Lamiaceae extract and ascorbic acid or it may comprise at least one Lamiaceae extract and acetic acid, etc. In other embodiments, the composition may comprise at least one Lamiaceae extract, acetic acid and ascorbic acid.

The invention also provides an anti-Clostridium composition comprising a composition comprising at least one phenolic diterpene and/or ascorbic acid and/or acetic acid and/or ursolic acid and any combinations thereof (second anti-Clostridium composition of the invention). As previously specified for the first composition of the invention, it is clearly understood that the second composition of the invention may comprise one, two or more of the components in any kind of combinations of the components. For example, the second composition of the invention may comprise only ascorbic acid, only at least one phenolic diterpene, or only acetic acid. For example, the composition may comprise ascorbic acid and acetic acid, or may comprise at least one phenolic diterpene and ascorbic acid or it may comprise at least one phenolic diterpene and acetic acid, etc. In other embodiments, the composition may comprise at least one phenolic diterpene, acetic acid and ascorbic acid. In other embodiments, the composition may comprise at least one phenolic diterpene and ascorbic acid and acetic acid and ursolic acid.

As mentioned before the anti-Clostridium compositions of the invention are inhibitors that inhibit spore germination and/or toxin production.

The compositions of the invention may further comprise other components like carriers, colors, texturizers, emulsifiers, etc.

In certain embodiments, the anti-clostridium compositions of the invention may comprise or may be use together with a red colorant or dye, specially a natural one. For example, the anti-clostridium compositions of the invention may further comprise or may be use together with an anthocyanin extract, a betalain extract and mixtures thereof.

### Anthocyanin

Anthocyanins are blue, red, or purple pigments found in plants, especially flowers, fruits, and tubers, such as blueberry, cranberry, and bilberry; Rubus berries, including black raspberry, red raspberry, and blackberry; blackcurrant, cherry, eggplant (aubergine) peel, black rice, ube, red sweet potato, Concord grape, muscadine grape, red cabbage, and violet petals.

In certain embodiments, the composition of the invention may further comprise an “anthocyanin(s) comprising extract” or “Anthocyanin extract”. An “anthocyanin(s) comprising extract” or “Anthocyanin extract” means any natural extract comprising at least one type of anthocyanins as described before that may be derived from, e.g., but not limited to Brassicaceae family, the Rosacae family, the Solanaceae family. In a preferred embodiment, the anthocyanin is from sweet potato.

### Betalains

Betalains are a class of red and yellow tyrosine-derived pigments found in plants of the order Caryophyllales, where they replace anthocyanin pigments. There are two categories of betalains:

Betacyanins, which appear reddish to violet. Examples of betacyanins present in plants include betanin, isobetanin, probetanin, and neobetanin; and

Betaxanthins, which appear yellow to orange. Betaxanthins present in plants include vulgaxanthin, miraxanthin, portulaxanthin, and indicaxanthin.

Therefore, the betalains used in the present invention may be betacyanins (such as betanin, isobetanin, probetanin, and neobetanin), betaxanthins (such as vulgaxanthin, miraxanthin, portulaxanthin, and indicaxanthin) or mixtures thereof.

Betalains are glycosides of a betanidin aglycone, whose core structure is betalamic acid (i.e. 4-(2-oxoethylidene)-1,2,3,4-tetrahydropyridine-2,6-dicarboxylic acid).

Betanin is usually obtained from the extract of the juice of Beta vulgaris (red beets, beetroot).

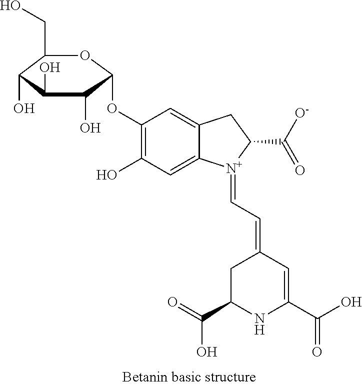

In certain embodiments, the betalain is a betanin.

Betacyanins (such as betanin, isobetanin, probetanin, and neobetanin) and betaxanthins (such as vulgaxanthin, miraxanthin, portulaxanthin, and indicaxanthin) may be obtained from different parts of plants such as the leaves, the fruits, the roots, the tuber or the stems.

In certain embodiments, the pigments comprising a Betacyanins (such as betanin, isobetanin, probetanin, and neobetanin) and/or a betaxanthins (such as vulgaxanthin, miraxanthin, portulaxanthin, and indicaxanthin) may be produced via fermentation using microorganism such as bacteria, fungus or yeast.

In certain embodiments, the pigments comprising a Betacyanins (such as betanin, isobetanin, probetanin, and neobetanin) and/or a betaxanthins (such as vulgaxanthin, miraxanthin, portulaxanthin, and indicaxanthin) may be obtained from beet roots (Beta vulgaris L.), amaranth (Amarathus sp.), pitahaya, Opuntia sp., Eulychnia sp. and Hylocereus sp., dragon fruits of mainly Hylocereus polyrhizus, colored Swiss chard (B. vulgaris L. ssp. cicla), Celosia argentea L., Bougainvillea sp. ulluco (Ullucus tuberosus Caldas) or bloodberries (berries of Rivina humilis L.) or mixtures thereof.

In certain embodiments, the composition of the invention may further comprise a “Betanin(s) comprising extract” or a “Betanin(s) extract”. A “Betanin(s) comprising extract” or a “Betanin(s) extract” means any natural extract comprising at least one type of betanins as described before that may be derived from, e.g., but not limited to Amaranthaceae family, the Cactaceae family. In a preferred embodiment, a beetroot extract is used.

The extracts defined above may be obtained or obtainable from the juice of the plant and then optionally dried.

Alternatively, the extract may be an aqueous extract, an alcohol extract (which includes hydro-alcoholic extracts), or an organic extract or may be an extract obtained using a combination of the aforementioned solvents. One or more purifications steps can be performed to obtain highly purified and enriched extracts.

The term “aqueous extract” as used herein, refers to the extract obtained when the extraction from the plant has been performed using water as the only solvent.

The term “alcohol extract” as used herein, refers to the extract obtained when the extraction from the plant has been performed using an alcohol as the solvent. The alcohol solvent may consist of only alcohol (e.g. 100% alcohol), for example 100% ethanol, or may be a mixture of an alcohol and water (i.e. a hydro-alcoholic solvent), for example, a mix of ethanol and water (hydro-ethanolic solvent), for example, from about 1% to about 99% alcohol (e.g. ethanol) in water, for example the ratio of water to alcohol is from 10/90% v/v to 90/10% v/v or 30/70% v/v to 70/30% v/v, such as 50/50% v/v or 70/30 v/v.

The term “organic extract” as used herein, refers to the extract obtained from a plant when the extraction has been performed using an organic solvent that is not an alcohol. For example, the organic solvent may be selected from the group consisting of acetic acid, acetone, acetonitrile, benzene, 2-butanone, carbon tetrachloride, chlorobenzene, chloroform, cyclohexane, 1,2-dichloroethane, diethylene glycol, diethyl ether, diglyme (diethylene glycol, dimethyl ether), 1,2-dimethoxy-ethane (glyme, DME), dimethyl-formamide (DMF), dimethyl sulfoxide (DMSO), 1,4-dioxane, ethyl acetate, ethylene glycol, glycerin, heptane, hexamethylphosphoramide (HMPA), hexamethylphosphorous, triamide (HMPT), hexane, methyl t-butyl, ether (MTBE), methylene chloride, N-methyl-2-pyrrolidinone (NMP), nitromethane, pentane, petroleum ether (ligroine), pyridine, tetrahydrofuran (THF), toluene, triethyl amine, o-xylene, m-xylene and p-xylene.

The present invention also provides a composition of the invention further comprising: (i) an anthocyanin extract and (ii) a betanin extract and mixtures thereof.

The present invention also provides a composition of the invention further comprising: (i) an anthocyanin extract obtainable from a plant from at least one of the Brassicaceae family, the Rosacae family, the Solanaceae family and mixtures thereof; and (ii) a betanin extract obtainable from a plant of the Caryophyllales order, particularly a plant of the Amaranthaceae family, the Cactaceae family, and mixtures thereof.

The composition of the invention may be used as a substitute of Nitrites. In particular, the composition may be used anti-clostridium solution in meat, fish or meat analogue having a pH of at about 4 or more (such as about 5 or more, or 6 or more) and/or a fat content of at about 1% or more by weight (such as 5% or more by weight, or 15% or more by weight), preferably processed meat, fish or meat analogue having a pH of at about 4 (such as about 5 or more, or 6 or more) or more and/or a fat content of at about 1% or more by weight (such as 5% or more by weight, or 15% or more by weight).

Where the anthocyanins are provided by an extract obtainable from a natural source, such as from a plant from at least one of the Brassicaceae family, the Rosacae family, the Solanaceae family or mixtures thereof, the extract may comprise anthocyanin compounds in an amount of at least 1 wt %, or at least 5%, or at least about 10 wt %, or at least 20 wt %, or at least 30 wt %, or at least 40 wt %, or at least 50 wt %. For example from about 10 wt % to about 99 wt %, or from about 30 wt % to about 80 wt %, or from about 40 wt % to about 70 wt %, or from about 1 wt % to about 50 wt %, or from about 50 et % to about 99 wt %.

In one embodiment, the anthocyanin (0.1% in pH 3.0) such as a red radish derived colour (0.1% in water) has a L* value of 58.89+/−5%, a* value of 69.81+/−5% and b* value of 51.43+/−5%.

Typically, the extracts defined herein may only contain low levels of peonidin-based anthocyanins. For example, in the extract less than 15 mol-% of all anthocyanins of the composition are peonidin-based anthocyanins, such as less than 10 mol-% or less than 5 mol-%.

The inventors of the present document, have proved that the combination of a Lamiaceae extract (or a composition comprising a phenolic diterpene) with ascorbic acid and/or acetic acid results in a synergistic effect against the germination of Clostridium spores and the production of toxins of Clostridium in a product. As it can be seen on the examples of the present application, using the method of the invention and treating sausages with the compositions and synergistic combinations of the invention (buffered vinegar, acerola juice and rosemary extract), the production of C. botulinum toxins was inhibited obtaining an extended shelf life of the product comparable to Nitrites.

Thus it is also object of the invention a method of preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of toxins of Clostridium in a product, comprising adding to the product a first anti-Clostridium composition of the invention or a second anti-Clostridium composition of the invention.

Thus it is also object of the invention a method of preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of toxins of Clostridium in a product, comprising adding to the product an anti-Clostridium composition comprising a Lamiaceae extract, ascorbic acid and/or acetic acid.

Thus it is also object of the invention a method of preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of toxins of Clostridium in a product, comprising adding to the product an anti-Clostridium composition comprising at least one phenolic diterpene, ascorbic acid and/or acetic acid.

The Lamiaceae extract, ascorbic acid and/or acetic acid may be added to the product in the form of a premixed composition (first anti-Clostridium composition of the invention) The at least one phenolic diterpene, ascorbic acid and/or acetic acid may be added to the product in the form of a premixed composition (second anti-Clostridium composition of the invention). The second composition of the invention may comprise one, two or the three components. For example, the second composition of the invention may comprise ascorbic acid and acetic acid, or may comprise at least one phenolic diterpene and ascorbic acid or it may comprise at least one phenolic diterpene and acetic acid.

The synergistic components of the first or second anti-Clostridium compositions of the invention may be also presented as a kit comprising the one, two or the three components and instructions on how to be used (rations, concentrations etc) and may be added to the product one after the other.

Therefore, the invention provides a method of preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of toxins of Clostridium in a product, comprising adding to the product a Lamiaceae extract, ascorbic acid and/or acetic acid. The three products when not forming part of a pre blend formulation/composition will be named as “synergistic combinations of the invention”.

Therefore, the invention provides a method of preventing and/or inhibiting the outgrowth of Clostridium, of preventing and/or inhibiting the germination of spores of Clostridium and/or of preventing and/or inhibiting the production of toxins of Clostridium in a product, comprising adding to the product at least one phenolic diterpene, ascorbic acid and/or acetic acid.

Clostridium is a genus of Gram-positive bacteria. Clostridium includes but is not limited to C. difficile, C. botulinum, C. sporogenes, Bacillus cereus, C. prefringens and Bacillus. subtilis.

In certain embodiments, the Clostridium is C. botulinum and/or C. perfringens.

C. botulinum is a Gram-positive, rod-shaped, spore-forming bacterium. It is an obligate anaerobe. C. botulinum is able to produce the neurotoxin only during sporulation, which can happen only in an anaerobic environment. In the present invention, the method is effective against any phenotypic group and to any serotype, including but not limited to phenotypic groups (I-IV) and serotypes A, B, C, D, E, F and/or G.

In the present invention as “prevent the outgrowth of Clostridium” it is understood that the method is capable of a reduction of bacteria growth and division of the vegetative bacteria of at least a 4 log, at least a 3 log, or at least a 2 log, or at least 1 log.

Spore producing bacteria, produce spores that are inactive and dormant structures.

The outgrowth of Clostridium vegetative cells may be measured using standard methods well known in the art such as the ones described herein in the examples.

In the present invention as “prevent the germination of spores of Clostridium” is understood that the method of the invention prevents the germination of the spores (passing from dormant structures to vegetative forms of the bacteria), for example wherein the method is capable of at least 4 log, at least a 3 log, at least a 2 log, at least 1 log reduction of bacterial spores germination of Clostridium, including but not limited to C. difficile, C. botulinum, C. sporogenes, B. cereus, and B. subtilis.

Spores produced by the bacteria Clostridium (such as C. botulinum) are heat-resistant and in the absence of oxygen they germinate, grow and then excrete toxins.

In the present invention as “prevent the production of toxins of Clostridium” is understood that an effective amount of the compositions of the invention can prevent the production and release of toxins form Clostridium to the product (such as a food product). The production of toxins from the Clostridium may be measured using methods such as the ones described herein in the examples.

The Lamiaceae extract, ascorbic acid and/or acetic acid may be added to the product in the form of a premixed composition (or anti-botulinum composition of the invention).

The three synergistic components (Lamiaceae extract, ascorbic acid and/or acetic acid) may be also presented as a kit comprising the three components and instructions on how to be used (rations, concentrations etc) and may be added to the product one after the other.

As used herein, the term “Lamiaceae extract” may refer to an extract from a plant of the Lamiaceae family, including but not limited to rosemary, sage, oregano, thyme, mints, and the following genera: Salvia (such as Salvia Apiana and Salvia officinalis), Rosmarinus (such as Rosmarinus officinalis), Lepechinia, Oreganum, Thymus, Hyssopus and any mixtures thereof.

The Lamiaceae material used for extracting the Lamiaceae extract can be any part of the plant such as leaves, roots, flowers, stems, etc. In a preferred embodiment, the part of the plant are the leaves and/or the stems.

The Lamiaceae material may be processed before extraction, for example it can be washed, dried, milled or grounded, etc.

The Lamiaceae extract (such as a rosemary and/or salvia extract) may be obtained or obtainable by the extraction of the aerial parts of a Lamiaceae extract (such as a rosemary and/or salvia extract) with acetone or ethanol (for example, aqueous ethanol) followed by optional purification depending on the concentration of the phenolic diterpene(s) required in the final extract.

Particular solvents that may be used in the extraction process include water, alcohols (such as methanol, ethanol), acetone, ethyl acetate, hexane, dichloromethane, and any mixtures thereof, such as alcohol/water mixtures (such as mixtures of methanol and water). For example, the extraction solvents can be water, a water-alcohol mixture (from about 1% to about 99% alcohol in water. For example, from about 30% to about 75% alcohol in water, or from about 30% to about 50% alcohol in water, such as from about 35% or from about 40% alcohol in water), or alcohol. Particular alcohols that may be mentioned include ethanol (EtOH) and methanol (MeOH).

In particular embodiments, the extraction solvent may be a ethanol-water mix, such as from about 30% to about 90% methanol in water, or from about 30% to about 50% ethanol in water. For example, from about 50% or from about 80% ethanol in water. In a preferred embodiment the extraction solvent is ethanol-water mix with about 75% ethanol and about 25% water.

The term “acetone extract” as used herein, refers to the extract obtained from any member of the Lamiaceae family (such as rosemary, salvia etc) when the extraction from the plant (particularly, leaves) has been performed using acetone as the only solvent.

The term “alcohol extract” as used herein, refers to the extract obtained from Lamiaceae when the extraction from the plant (particularly leaves) has been performed using alcohol as the only solvent. For example, 100% methanol and/or 100% ethanol. The term “hydroalcoholic extract’ as used herein, refers to the extract obtained from Lamiaceae (such as rosemary, salvia etc) when the extraction from the plant has been performed using a mixture of water and alcohol. For example, from about 1% to about 99% alcohol (e.g. ethanol, methanol) in water, such an extract would be termed a hydro-alcoholic extract (such as an hydroethanolic extract).

In one preferred embodiment, the Lamiaceae extract is a hydro-ethanolic extract.

A detailed procedure to prepare a Rosemary extract was described in the U.S. Pat. No. 5,859,293 (PCT WO96/34534), which is incorporated herein by reference in its entirely.

For example, processes for extraction and isolation of extracts of the invention may comprise (or consist essentially/consist of) the following steps:
(i) extraction of Lamiaceae leaves and/or stems (such as rosemary and/or salvia which may be ground) by a suitable solvent (such as acetone, ethanol, water or mixtures thereof);
(ii) evaporation of the solvent; and, if required
(iii) purification of the extract (e.g. by chromatography).

In one embodiment, the temperature of extraction is in a range of from about 20° C. to about 100° C. In a particular embodiment, the temperature for extraction is in a range of from about 50° C. to about 70° C. Typically, the ratio of plant material to solvent mixture used in the extraction process varies from about 1:1 to about 1:10 on a gram to milliliter basis, such as from about 1:3 to about 1:8. The incubation period (i.e. the period during which the plant material is in contact with the solvent) is typically from about 2 hours to about 24 hours.

Mechanical energy can be applied during the extraction process. Applying mechanical energy helps to homogenize the mixture, changes the physical structure of the starting biological material and increases the extraction yields of phenolic diterpene(s). The amount of mechanical energy applied in the method depends on at which step applied, the type of Lamiaceae material, the amount of the starting material used in the mixture, the pH of the mixture, and the temperature of the mixture. The amount of mechanical energy also can influence the amount of time needed to complete the extraction of the phenolic diterpene(s).

For example, the Lamiaceae material (such as rosemary and/or salvia) and the extraction solution (such as acetone, ethanol, water or mixtures thereof) may be mixed using techniques known in the art, for example using stirring, maceration, percolation or infusion, such as magnetic or mechanical stirring.

After the Lamiaceae material (such as rosemary and/or salvia leaves) and the solvent have been incubated, the solvent is separated from residual Lamiaceae material by any suitable separation technique known in the art (like for example filtration).

Further filtration steps can be used. The solvent may be partially or totally removed by any method known in the art such as centrifugation, Rota vap, and any device allowing solvent evaporation or a liquid-liquid way of replacing the solvent. Further filtration steps can be used. For example, in a preferred embodiment, aqueous sodium carbonate (NaHCCh) may be added to dissolve carnosic acid and other organic acids, while base insoluble substances are precipitated out. The solution may be filtered to separate from solid, and the filtrate can be further concentrated under reduced pressure. In a further step, after finishing concentration is achieved, phosphoric acid (H3PO4) may added and the acid insoluble substances (including carnosic acid, carnosol, and carnosic derivatives) are precipitated from the concentrated solution. Additionally, the result may be fileted and the solid precipitate may be subsequently separated from liquid and rinsed with water to remove impurities.

In one embodiment, the Lamiaceae extract comprises phenolic diterpenes.

As used herein, the term “Phenolic diterpenes” may refer to carnosic acid, carnosol, methylcarnosate, and other phenolic diterpene derivatives (rosmanol, isorosmanol, 1 1, 12-di-O-methylisorosmanol, 12-O-methylcarnosic acid, rosmanol-9-ethyl ether, circi-maritin, Methylated monooxidized product of carnosic acid, genkwanin, epirosmanol, epiisorosmanol, carnosic acid derivative, epirosmanol ethyl ether, cryptotanshinone) and mixtures thereof.

In some embodiment, the Lamiaceae extract (such as rosemary and/or salvia extract) comprises at least about 1%, at least about 2%, at least about 3%, at least about 4%, at least about 5%, at least about 6%, at least about 7%, at least about 8%, at least about 9%, at least about 10%, at least about 15%, at least about 20%, at least about 30%, at least about 40%, at least about 50%, at least about 60%, at least about 70%, at least about 80%, at least about 90%, at least about 95%, or at least about 99 wt % of one or more phenolic diterpenes such as the ones described before. In a preferred embodiment, the Lamiaceae extract(s) that may be used in the present method of the invention comprises carnosic acid and/or carnosol.

In certain embodiments, the first anti-Clostridium composition of the invention used in the methods of the invention comprises at least one Lamiaceae extract (such as rosemary and/or salvia extract) comprising at least about 35% w/w of phenolic diterpenes (such as carnosic acid and/or carnosol).

In certain embodiments, the Lamiaceae extract (such as rosemary and/or salvia extract) may comprise (or consist essentially/consist of) the following phenolic diterpenes: carnosic acid and/or carnosol. In certain embodiments, the ratio between carnosic acid and carnosol is from 40:1 to 1:40, such as 30:1, 20:1, 10:1, 5:1 or 1:1.

As already mentioned, the lamiaceae extract (such as rosemary and/or salvia extract) comprises carnosic acid and/or carnosol. In a preferred embodiment, the Lamiaceae extract (such as rosemary and/or salvia extract) comprise from 1% w/w to about 99.9% w/w or carnosic acid and/or carnosol, such as from about 4% w/w to about 40% w/w, such as from about 1% w/w to 5% w/w, such as about 1% w/w or about 2% w/w.

In certain embodiments, the Lamiaceae extract (such as rosemary and/or salvia extract) may comprise (or consist essentially/consist of):
a) from about 1%, 5%, 10%, 15%, 20%, 25%, 30%, 35%, 40% or 45% to about 95%, 90%, 85%, 80%, 75%, 70%, 65%, 60%, 55% or 50% by weight of the final extract (w/w) of carnosic acid, such as from about 20% to about 80% w/w, preferably such as from about 30% to about 50% w/w such as about 40% w/w; and/or
b) from about 1%, 5%, 10%, 15%, 20%, 25%, 30%, 35%, 40% or 45% to about 95%, 90%, 85%, 80%, 75%, 70%, 65%, 60%, 55% or 50% of carnosol by weight of the final extract (w/w), such as from about 1% to 20% w/w such as from about 2% to about 10% w/w, preferably such as from about 3% to about 5% w/w, such as about 4% w/w.

In particular embodiments, the Lamiaceae extract (such as rosemary and/or salvia extract) may be: substantially free of other plant material (e.g. free of plant cellulose); substantially free of plant cells; substantially free of plant cellular matter, substantially free of toxic components like pesticides, quintozene, aflatoxins, ochratoxin A, cadmium, arsenic, lead or mercury, substantially free of solvents and/or substantially free of volatile oil components.

In a particular embodiment, the Lamiacea extract is an extract wherein a majority of the volatile oil components have been removed.

As used herein, the term “volatile oil components” may refer to compounds like essential oils such as: (-)-borneol, (-)-bornyl acetate, (-)-camphor, 1,8-Cineole (eucalyptol) and verbenone.

In one embodiment the ration between the total % of phenolic diterpene(s) (such as carnosic acid and carnosol)/Total % of volatiles oil components (such as (-)-borneol, (-)-bornyl acetate, (-)-camphor, 1,8-Cineole (eucalyptol) and verbenone) is not less than 15.

The inventors of the present invention have also surprisingly discovered that Lamiaceae extracts rich in ursolic acid (for example comprising about 35% w/w of ursolic acid) also provide anti-clostridium effects. Therefore, in certain embodiments, the Lamiaceae extract may comprise Ursolic acid. For example, in certain embodiments, the Lamiaceae extract comprises from about 1%, 5%, 10%, 15%, 20%, 25%, 30%, 35%, 40%, 45%, 50%, 60%, 70% or 80% to about 95%, 90%, 85%, 80%, 75%, 70%, 65%, 60%, 55%, 50%, 40%, 30%, 20% or 10% by weight of the final extract (w/w) of ursolic acid, such as from about 20% to about 80% w/w, preferably such as from about 30% to about 50% w/w such as about 35% w/w of ursolic acid.

In certain embodiments, the Lamiaceae extract may comprises ursolic acid and at least one phenolic diterpene.

In certain embodiments, the Lamiaceae extract may be substantially free of volatile compounds. As used herein, references to a material being “substantially free” of another material may refer to the material consisting of less than 1% by weight (e.g. less than 0.1%, such as less than 0.01% or less than 0.001%, by weight) of that other material.

In certain embodiments, the Lamiaceae extract has less than 1% of essential oils, volatile oils and/or other compounds that provide a taste or a flavor. Those extracts are known as deodorized extracts.

The Lamiaceae extract (such as rosemary and/or salvia extract) may be present in the composition in an amount from about 0.1% w/w to about 90% w/w, such as from about 1% w/w to about 25% w/w, such as from about 2% w/w to about 10% w/w, such as about 2% w/w or about 5% w/w, or such as about 20% w/w to 30% w/w, such as about 23% w/w.

The present invention is also related to a method of preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of toxins in a product, comprising adding to the product at least one phenolic diterpene, ascorbic acid and/or acetic acid.

The present invention is also related to a method of preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of toxins in a product, comprising adding to the product at least one of ursolic acid, ascorbic acid and/or acetic acid.

The present invention is also related to a method of preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of toxins in a product, comprising adding to the product at least one phenolic diterpene ursolic acid, ascorbic acid and/or acetic acid.

The at least one phenolic diterpene, ursolic acid, ascorbic acid and/or acetic acid may be added to the product in the form of a premixed composition as already mentioned before (second composition of the invention).

The different components (at least one phenolic diterpene, ursolic acid, ascorbic acid and/or acetic acid) may be also presented as a kit comprising the three components formulated separately and instructions on how to be used (rations, concentrations etc) and may be added to the product one after the other.

The present invention is also related to a method of preventing or inhibiting the outgrowth of Clostridium, of preventing or inhibiting the germination of spores of Clostridium and/or of preventing or inhibiting the production of toxins of Clostridium in a product, comprising adding to the product a composition comprising at least one phenolic diterpene, ascorbic acid and/or acetic acid (second composition of the invention).

The present invention is also related to a method of preventing or inhibiting the outgrowth of Clostridium, of preventing or inhibiting the germination of spores of Clostridium and/or of preventing or inhibiting the production of toxins of Clostridium in a product, comprising adding to the product a composition comprising at least one phenolic diterpene, ursolic acid, ascorbic acid and/or acetic acid.

The wording “at least one phenolic diterpene, ursolic acid, ascorbic acid and/or acetic acid” in the present invention means that one or more of the components may be used, for example only at least one phenolic diterpene, or a combination of at least one phenolic diterpene and urisolic acid; or for example at least one phenolic diterpene and ascorbic acid and acetic acid, or any other combination of said components.

It is also object of the invention a method of preventing and/or inhibiting the outgrowth and/or of preventing and/or inhibiting the germination of spores of a spore forming bacteria selected from Geobacillus, the genus Morpherella (Moorella), the genus Thermoanaerobacter (Thermoanaerobacter), the genus Thermoanaerobacterium and/or the genus Alicyclobacillus; in a product, comprising adding to the product a composition of the invention.

It is also object of the invention a method of preventing and/or inhibiting the outgrowth and/or of preventing and/or inhibiting the germination of spores of a spore forming bacteria selected from Geobacillus, the genus Morpherella (Moorella), the genus Thermoanaerobacter (Thermoanaerobacter), the genus Thermoanaerobacterium and/or the genus Alicyclobacillus; in a product, comprising adding to the product a Lamiaceae extract, ascorbic acid and/or acetic acid.

It is also object of the invention a method of preventing and/or inhibiting the outgrowth and/or of preventing and/or inhibiting the germination of spores of a spore forming bacteria selected from Geobacillus, the genus Morpherella (Moorella), the genus Thermoanaerobacter (Thermoanaerobacter), the genus Thermoanaerobacterium and/or the genus Alicyclobacillus; in a product, comprising adding to the product at least one phenolic diterpene, ursolic acid, ascorbic acid and/or acetic acid.

As already mentioned before, the term “Phenolic diterpene” may refer to carnosic acid, carnosol, methylcarnosate, and other phenolic diterpene derivatives (rosmanol, isorosmanol, 1 1, 12-di-O-methylisorosmanol, 12-O-methylcarnosic acid, rosmanol-9-ethyl ether, circi-maritin, Methylated monooxidized product of carnosic acid, genkwanin, epirosmanol, epiisorosmanol, carnosic acid derivative, epirosmanol ethyl ether, cryptotanshinone) and mixtures thereof.

Phenolic diterpene(s) may be of natural origin or may be of synthetic origin. For example, Phenolic diterpenes may be obtained from a plant of the Lamiaceae family, including but not limited to rosemary, sage, oregano, thyme, mints, and the following genera: Salvia (such as Salvia Apiana and Salvia officinalis), Rosmarinus (such as Rosmarinus officinalis), Lepechinia, Oreganum, Thymus, Hyssopus and any mixtures thereof, specially from the leaves as already described herein.

As “ascorbic acid” in the present application is understood acide ascorbique and/or its salt, including but not limited to ascorbate de sodium, acide erythorbique and erythorbate de sodium. The ascorbic acid and its salts that may be used in the present invention may be of a natural or a synthetic origin. In a preferred embodiment, ascorbic acid and/or its salt is obtained from some natural source rich in ascorbic acid including but not limited to acerola (Malpighia glabra L.), citrus family (citrus genus) including but not limited to orange, lemon, calamansi, lime, kumquat, mandarin and grapefruit), etc. Also ascorbic acid and/or its salt obtained using fermentation methods are included herein. Ascorbic acid and/or its salt maybe further purified to obtain highly concentrated ascorbic acid and/or its salt.

Thus, in certain embodiments, the compositions (such as anti-Clostridium compositions of the invention) used in the methods of the invention comprises an acerola extract (such as a juice, dry juice, etc) and it may be present in the composition in an amount from about 1% to about 90%, such as from about 2% to about 50%, such as from about 5% to about 30% or about 9% or about 25%. In certain embodiments, the acerola extract is present from 5% to 10% and has a ascorbic contain of at least 30% w/w.

In certain embodiments, the compositions (such as anti-Clostridium compositions of the invention) used in the method of the invention may comprise ascorbic acid in an amount from about 0.1% to about 99.9%, such as from about from 1% w/w to 30% w/w, such as from 1% w/w to about 25% w/w, such as from about 1% w/w to 10%, such as from 2% w/w to about 10% w/w, such as 3%, 4% w/w, 5% w/w or about 9% w/w.

In certain embodiments, the acerola extract (such as a concentrate juice) may have a concentration of ascorbic acid of at least 10% w/w, such as at least 20%, at least 30%, such as at least 40% w/w.

The acerola extract (such as a juice) may be dried using such techniques known in the art to provide an ascorbic acid rich powder.

The acetic acid in the present invention includes acetic acids and any of its salt. The acetic acid may be present in the compositions of the invention in an amount from about 2% to about 99%, such as from about 2% w/w to about 90% w/w, such as from about 2% w/w to about 50% w/w, such as from about 3% w/w to about 30% w/w, 3% to about 20% w/w, such as from about 5% w/w to 20% w/w, such as about 10% w/w to about 30% w/w, such as about 10% w/w or such as about 20% w/w, or about 5% w/w, 17% w/w.

In certain embodiments, the acetic acid is from buffered vinegar and the concentration of acetic acid in the composition of the invention is from 3% w/w to about 30% w/w, such as from 10 to 20% w/w such as 17% w/w.

In certain embodiments, the acetic acid is from non-buffered vinegar and the concentration of acetic acid in the composition of the invention is from 2% w/w to about 20% w/w, such as from 2% to 10% w/w such as 5% w/w.

Any source of acetic acid may be use in the present invention, including but not limited to vinegar, non-buffered vinegar, buffered vinegar, concentrated vinegar, non-concentrated vinegar or any mixtures thereof. The vinegar includes but is not limited to white wine vinegar, champagne vinegar, rice vinegar, apple cider vinegar, raisin vinegar, apricot vinegar, sherry vinegar, malt vinegar, beer vinegar, red vinegar, red wine vinegar, balsamic vinegar or black vinegar). The vinegar may be concentrated or not. The vinegar may be buffered or not. The vinegar may be used in solid (such as a dry powder) or as a liquid. Acetic acid obtained using fermentation methods known in the art are also included herein.

The acetic acid may be used as a liquid or may be used as a powder. The acetic acid may be dried using such techniques known in the art to provide an acetic acid rich powder.

For example, vinegar (such as buffered vinegar or non-buffered vinegar) may be a source of acetic acid. Vinegar (such as buffered vinegar or non-buffered vinegar) may be present in the composition in an amount from about 10% w/w to about 99% w/w, such as from about 20% w/w to about 90% w/w, such as from about 30% w/w to about 80% w/w, such as from about 20% w/w to about 60% w/w, such as about 28% w/w, or such as bout 52% w/w, or about 70% w/w.

The vinegar (such as buffered vinegar or non-buffered vinegar) may be dried by any method know in the art so as to obtain an acetic rich powder containing at least 5% w/w, such as at least 10%, at least 15%, 20%, 25%, 30%, 40%, 50%, 60% such as at least 80% acetic acid.

In certain embodiments of the methods or process of the invention, the concentration of carnosic acid in the final product (such as a meat, fish or to a meat analogue product) is from about 5 ppm, 10 ppm, 12 ppm, 15 ppm, 20 ppm, 30 ppm, 40 ppm, 50 ppm, 60 ppm, 70 ppm, 80 ppm, 90 ppm, 100 ppm, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as from 50 ppm to 1000 ppm; and/or the concentration of carnosol in the final product is from about 2 ppm, 5 ppm, 10 ppm, 15 ppm, 20 ppm, 30 ppm, 40 ppm, 50 ppm, 60 ppm, 70 ppm, 80 ppm, 90 ppm, 100 ppm, to about 3%, 2%, 1% (10000 ppm), 3000 ppm, 2000 ppm, 1000 ppm, 800 ppm, 600 ppm, 500 ppm, 400 ppm, 300 ppm to 200 ppm w/w, such as 5 ppm to 100 ppm. In one embodiment, the ratio between carnosic acid and carnosol is from 40:1 to 5:1, such as 30:1, 20:1, 10:1 or 5:1.

In certain embodiments of the methods or process of the invention, the concentration of ascorbic acid in the final product (such as a meat, fish or to a meat analogue product) is from about 12 ppm, 15 ppm, 20 ppm, 30 ppm, 40 ppm, 50 ppm, 60 ppm, 70 ppm, 80 ppm, 90 ppm, 100 ppm, 150 ppm to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as from 50 ppm to 1000 ppm, in respect to the final weight of the product.

In certain embodiments of the methods or process of the invention, the concentration of acetic acid in the final product (such as a meat, fish or to a meat analogue product) is from about 12 ppm, 15 ppm, 20 ppm, 30 ppm, 40 ppm, 50 ppm, 60 ppm, 70 ppm, 80 ppm, 90 ppm, 100 ppm, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm, such as from 50 ppm to 1000 ppm, such as 500 ppm in respect to the final weight of the product.

In certain embodiments of the methods or process of the invention, the concentration of carnosic acid in the final product (such as a meat, fish or to a meat analogue product) is from about 5 ppm, 10 ppm, 15 ppm, 20 ppm, 30 ppm, 40 ppm, 50 ppm, 60 ppm, 70 ppm, 80 ppm, 90 ppm, 100 ppm, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as from 50 ppm to 1000 ppm; and/or the concentration of carnosol in the final product is from about 5 ppm, 10 ppm, 15 ppm, 20 ppm, 30 ppm, 40 ppm, 50 ppm, 60 ppm, 70 ppm, 80 ppm, 90 ppm, 100 pp, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as 5 ppm to 100 ppm, the concentration of ascorbic acid in the final product is from about 12 ppm, 15 ppm, 20 ppm, 30 ppm, 40 ppm, 50 ppm, 60 ppm, 70 ppm, 80 ppm, 90 ppm, 100 ppm, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as from 50 ppm to 1000 ppm; and/or the concentration of carnosol in the final product is from about 5 ppm, 10 ppm, 15 ppm, 20 ppm, 30 ppm, 40 ppm, 50 ppm, 60 ppm, 70 ppm, 80 ppm, 90 ppm, 100 pp, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as 5 ppm to 100 ppm, in respect to the final weight of the product.

For example, the anti-botulinum compositions of the invention may be present in the product in an amount of from about 0.1 g/kg to about 20 g/kg, such as from about 0.5 g/kg to about 15 g/kg, such as from about 0.5 g/kg to about 5 g/kg, such as 1 g/kg to about 15 g/kg, such as from about 0.5 to about 15 g/kg, such as 3 g/kg, 5 g/kg and 10 g/kg.

The ratio between acetic acid and ascorbic acid may be from 95:3 to 20:60, such as 90, 80, 70, 60, 50, 40, 30, 20:3, 5, 10, 20, 30, 40, 50 or 60, such as from 80:10 to 80:20, such as 71:24 to about 35:56, such as 80:15 or 30:60 or such as 77:17.

The ratio between ascorbic acid and the at least one phenolic diterpene (such as carnosic acid and carnosol) may be from 3:2 to 60:20, such as from 3, 5, 10, 20, 30, 40, 50, or 60:2, 5, 10 or 20, such as 15:5 or 60:10, such as 24:5 to about 56:8, such 17:6.

The ratio between acetic acid, ascorbic acid and the at least one phenolic diterpene (such ascarnosic acid and carnosol) may be from 95:3:2 to 20:60:20, such as 80:15:5 or 30:60:10, such as 71:24:5 to about 35:56:8, such as 77:17:6.

In certain embodiments, the Lamiaceae extract (such as rosemary and/or salvia extract) is added so as to provide from 5 ppm to 1%, such as from 5 ppm to 200 ppm, such as from 10 ppm to 100 ppm, such as about 40 ppm of at least one phenolic diterpene in respect to the final weight of the product, ascorbic acid is added to the product so as to provide a final concentration in the product of from 10 ppm to 1%, such as from 50 ppm to 500 ppm such as from 100 ppm to 200 ppm, such as 110 μm in respect to the final weight of the product, and acetic acid is added to the product so as to provide a final concentration in the product of from 10 ppm to 1%, such as from 100 ppm to 1000 ppm, such as 500 ppm in respect to the final weight of the product.

In certain embodiments, at least one phenolic diterpene is added to the product so as to obtain a concentration in the final product of from 5 ppm to 1%, such as from 5 ppm to 200 ppm, such as from 10 ppm to 100 ppm, such as about 40 ppm of at least one phenolic diterpene in respect to the final weight of the product, ascorbic acid is added to the product so as to provide a final concentration in the product of from 10 ppm to 1%, such as from 50 ppm to 500 ppm such as from 100 to 200 ppm, such as 110 μm in respect to the final weight of the product, and acetic acid is added to the product so as to provide a final concentration in the product of from 10 ppm to 1%, such as from 100 ppm to 1000 ppm, such as 500 ppm in respect to the final weight of the product.

As already mentioned, the inventors of the present document, have shown that the synergistic compositions and combinations of the invention are effective in preventing and/or inhibiting the outgrowth of Clostridium, the germination of spores of Clostridium and/or the production of toxins of Clostridium, and may be used in any product where a risk of contamination of Clostridium is suspected. For example, the product to which the compositions or synergistic combinations may be incorporated, includes but is not limited to a food or a beverage product for humans or animals, a nutritional supplement, a nutraceutical formulation, a fragrance or flavouring, a pharmaceutical or veterinary formulation, an oenological or cosmetic formulation.

According to some embodiments, the compositions of the invention may also be used to treat surfaces, such as food handling surfaces (e.g., countertops, food handling equipment and utensils), general premise surfaces (e.g., floors, walls, ceilings, exterior of furniture, etc.), or equipment surfaces (e.g., medical equipment, manufacturing equipment, processing equipment, etc.). The composition can be applied to the surface to be treated by any suitable method, such as spraying, pouring, dripping, wiping, or mopping, etc. The composition can be provided as, for example, a ready-to-use spray or cleaning wipe. In one embodiment, the composition is applied to the surface as a mixture. In another embodiment, the composition is a two part composition, where part I is applied to the surface first, and part II second. A two-part composition can also be used by mixing parts I and II together prior to application to a surface or to an object. In certain embodiments, if the food product is packaged, the contained may be treated with the compositions of the invention.

The methods of the invention may be methods of producing a product and may further comprise a step of packaging said product (such as a food or drink).

The final product it may be then a packaged product such as a packaged food or beverage.

“Packaged food or beverage” in the present invention means a food or beverage packed in a container, that is, a beverage or food packed in a container. Such a food product is not particularly limited, but preferably includes fats and/or milk, or a food product containing a protein, which is susceptible to degradation by spore-forming bacteria such as Clostridium bacteria. Preferable specific examples of meat packaged products include processed meat products such as sausages, knackers, bacon, cooked ham, etc. Furthermore, among the packaged beverages described above, a packaged low-acid beverage can be suitably exemplified. Such a “packaged low acid beverage” means a low acid beverage packed in a container. The “low-acidity beverage” refers to a beverage having a pH of 4.6 or more (preferably 4.6 or more and 10 or less). Fat and/or milk, or a protein-containing low-acidity beverage, specifically fat and/or milk-containing coffee beverages, fat and/or milk-containing black tea beverages, fat and/or milk-containing cocoa beverages, potato soup beverages, soup beverages, and the like. Also non diary beverages are included, that contain different vegetable proteins such as protein derived from raw peas or the like.

Any container normally used in beverages can be used as the container in the packaged food or drink. In the present invention, the method for producing a product (such as a food or drink) and the method for packaging said product (such as a food or drink) do not differ from known methods. That is, the product (such as a food or drink) can be produced by publicly known raw materials and production conditions used in the production of for example food or beverage, nutraceuticals, cosmetics, etc. For instance, the food or drink can be used as a packaged food or drink by filling the food or drink in a container and sealing the food or heat sterilizing the food or drink in advance, aseptically filling the food or drink in a container and sealing the food or drink. The sterilization method for packaged food or beverage is preferably heat sterilization, particularly retort sterilization, performed after packaging. Examples of the food or beverage container preferably include containers such as cans, pet bottles, retort containers, and the like that are distributed at room temperature and stored for a long period of time. Among these, can containers and retort containers that are subjected to retort sterilization after packaging are preferable. Examples of the form of sale and distribution of these foods and drinks include distribution of sales temperatures such as ambient temperature, cold, hot, and the like, but the bacteriostatic agents, anti-Clostridium composition of the present invention can exhibit bacteriostatic action, anti-Clostridium effect (anti-sporulation and anti-toxin production) at any sales temperature.

In certain embodiments, the product (such as a food or drink, packaged food or beverage products) in the methods of the present invention, may be summited to heat sterilization treatment. In certain embodiments, the sterilization treatment is preferably performed before adding the compositions of the invention to the production raw material. In certain embodiments, the sterilization treatment is preferably performed after adding the compositions of the invention to the production raw material.

The degree of heat sterilization treatment may be appropriately selected as necessary, but in the case of retort sterilization, heat sterilization treatment) or greater at an Fo value of 10 (121° C. for 10 minutes and preferably heat sterilization treatment) or greater at an Fo value of 12.5 (121° C. for 12.5 minutes; More preferably a heat sterilization process of 17.5 minutes at an Fo value of 17.5 (121° C. is) or higher, and the upper limit is a Fo value of 150 or lower from the perspective of flavor and appearance of the packaged food or beverage. In the case of UHT sterilization (ultra high temperature sterilization), conditions corresponding to retort sterilization described above can be suitably exemplified. Note that the preferred degree of the heat sterilization treatment described above can be particularly suitably applied when the packaged food or beverage is a packaged low acid beverage.

The packaged food or beverage itself is also included in the present invention.

The product (such as a food or beverage), packaged or not, of the present invention may be essentially free of nitrite and nitrate. The concentration of the nitrite and nitrate salts in the product (such as a food or beverage), packaged or not, of the present invention, is preferably less than 250 ppm, more preferably less than 200 ppm, even more preferably less than 150 ppm, and most preferably 0 ppm.

“Essentially free of nitrite and nitrate” means in the present invention that no external sources of Nitrite and/or nitrate are added to the final product. For example, the final product preferably has less than 100 ppm, such as less than 50 ppm, such as less than 10 ppm, such as less than 5 ppm of Nitrite and/or nitrate, such as 0 ppm.

The method for producing a product (such as a food or beverage), packaged or not, includes a step of adding the compositions of the invention or the synergistic combinations of the invention to production raw materials, as defined previously. Except that the production method of the present invention includes a step of adding the compositions of the invention and synergistic combinations defined herein to production raw materials, there is no particular difference from conventional methods for producing packaged food or drink, and the method includes, for example, a blending step of blending raw materials, a filling step of filling a container with the raw materials produced by the blending step, and a sterilization step. In addition to using the compositions of the invention and synergistic combinations defined herein of the present invention at a prescribed concentration, any raw material may be used, and the blending method may be optional.

The production raw material before or after adding (preferably adding and mixing) the compositions of the invention and synergistic combinations defined herein to the object is preferably subjected to heat sterilization or heat treatment. The production raw material after adding the compositions of the invention and synergistic combinations defined herein is preferably subjected to heat sterilization. Note that “production raw materials” in the present specification refer to raw materials used in the production of foods, drinks cosmetics, nutritional products etc, and for convenience, include raw materials at a stage during which a food and drink product is produced from the raw materials, as well as food and drink products.

As already mentioned, in certain embodiments, the anti-clostridium compositions of the invention may comprise or may be use together with a red colorant or dye, specially a natural one. For example, the anti-clostridium compositions of the invention may further comprise or may be use together with an anthocyanin extract, a betalain extract and mixtures thereof.

In certain embodiments, the product, such as a food product, may further comprise an anthocyanin extract, a betalain extract and mixtures thereof.

In certain embodiments, the food product may typically be a meat or fish product comprising about 1% or more fat (such as 5% or more, or 15% or more) by weight of the food product and/or has a pH of about 4 of more (such as about 5 or more, or 6 or more).

The fat may be fat from the meat of fish used in the process or may be added from other sources. The fat may be of animal (such as pork, beef fat etc) or vegetal origin (such as palm oil, coconut, oil, olive oil, etc), and mixtures thereof.

In particular, the meat or fish product may be a processed meat, process fish product or a meat analogue.

By the term “processed” we mean that the meat or fish has been modified away from their original form. For example, by mincing, emulsifying, curing, salting, smoking, drying or canning. Processed meat products include, but are not limited to, mixed fresh products, emulsified cooked products, brined cooked products or dried products such as bacon, ham, sausages, pate, salami, corned beef, jerky, hot dog, luncheon meat, canned meat and meat-based sauces, etc. In particular, the food product may be an emulsified food product such as frankfurter or hot dogs, cervelas, pates, etc.

The process fish may be a fish pate or fish paste, rillettes, smoked fish, pickled fish, etc. The processed meat or fish products may be cooked or uncooked. The processed meat may also include pet food products. The processes food may be also a meat analogue.

In the present invention, the food may be cooked. Thus, in certain embodiments, the food product may have been subjected to a temperature of 40° C. or above for at least 10 minutes. The food product may have been subjected to a constant temperature for at least 10 minutes, or at least 1 hour, at least 10 hours, at least 20 hours; or may be subjected to increasing temperatures for several time periods. For example, the food product may be subjected to a temperature of 50° C. during 20 min, then at 55° C. during about 10 min, then at 74° C. during about 23 min and finally cooled until 10° C. during 5 min. The relative humidity during the heating process may be from about 10% relative humidity to about 99% of relative humidity. In a preferred embodiment, the food product (such as emulsified sausages like Frankfurter or hot dogs, cervelas etc) may be subjected to a temperature of about 50° C. during about 20 min (at a 99% relative humidity), then 55° C. during about 10 min, 74° C. during about 23 min and finally cooled until 10° C. during 5 min (at 10% relative humidity). In another embodiment the temperature may be of 80° C. and the time of heating may be up to 15-16 hours (such as for cooked ham).

This step of heating may be performed before the packaging. The packaging may be a vacuum packaging.

This process of heating the product during relatively long periods at temperatures that do not permit sterilization of the product, may increase the risk of contamination of the product by Clostridium and may increase the risk of toxin production in the processed food product. The inventors of the present invention, have surprisingly found that the compositions of the invention and the synergistic combinations defined in the methods of the present invention permits to obtain a process food free of Clostridium contamination (inhibition of Clostridium sporulation and toxin production) with a shelf life comparable to a Nitrite control product (see example 1 and tables 3, 4, 5 and 6).

As noted above, the food product may comprise about 1% of more fat and/or has a pH of about 4 of more. As already mentioned the fat may be originally present in the product meat or added during the processing.

Typically, the food product may have a fat content of from about 1% to about 60%, or from 5% to about 50% by weight of the product, such as from about 10% to about 40% by weight or from about 20% to about 30%.

Typically, the food product may have a pH of from about 4 to about 10, or from about 5 to about 8, or from about 6 to about 7, such as about 6.5. pH is measured by standard techniques such as a pHmeter.

The product (such as a food or beverage), packaged or not, may have a pH in the range of about 4.6 to about 8.5, such as 5.8 to about 6.2. The product (such as a food or beverage), packaged or not, may have a salt content less than about 5.0% by weight.

Food or foodstuff encompasses the following general food categories, as defined by the Food and Drug Administration (FDA): baked goods and baking mixes, including all ready-to-eat and ready-to-bake products, flours, and mixes requiring preparation before serving; beverages, alcoholic, including malt beverages, and cocktail mix; beverages and beverage bases, non-alcoholic, including only special or spiced teas, soft drinks, coffee substitutes, and fruit and vegetable flavoured gelatin drinks; cheeses, including curd and whey cheeses, cream, natural, grating, processed, spread, dip, and miscellaneous cheeses; chewing gum, including all forms; coffee and tea, including regular, decaffeinated, and instant types; condiments and relishes, including plain seasoning sauces and spreads, olives, pickles, and relishes, but not spices or herbs; confections and frostings, including candy and flavoured frosting, marshmallows, baking chocolate, and brown, lump, rock, maple, powdered, and raw sugars; toppings, and other nondairy products; egg products, including liquid, frozen, or dried eggs, and egg dishes made therefrom, i.e., egg roll, egg foo young, egg salad, and frozen multicourse egg meals, but not fresh eggs; fats and oils, including margarine, dressings for salads, butter, salad oils, shortenings and cooking oils; fish products, including all prepared main dishes, salads, appetizers, frozen multicourse meals, and spreads containing fish, shellfish, and other aquatic animals, but not fresh fish; fresh eggs, including cooked eggs and egg dishes made only from fresh shell eggs; fresh fish, including only fresh and frozen fish, shellfish, and other aquatic animals; fresh meats, including only fresh or home-frozen beef or veal, pork, lamb or mutton and home-prepared fresh meat-containing dishes, salads, appetizers, or sandwich spreads made therefrom; fresh poultry, including only fresh or home-frozen poultry and game birds and home-prepared fresh poultry-containing dishes, salads, appetizers, or sandwich spreads made therefrom; pastas, including macaroni and noodle products, rice dishes, and frozen multicourse meals, without meat or vegetables; gravies and sauces, including all meat sauces and gravies, and tomato, milk, buttery, and specialty sauces; herbs, seeds, spices, seasonings, blends, extracts, and flavourings, including all natural and artificial spices, blends, and flavours; meat products, including all meats and meat containing dishes, salads, appetizers, frozen multicourse meat meals, and sandwich ingredients prepared by commercial processing or using commercially processed meats with home preparation; milk, whole and skim, including only whole, lowfat, and skim fluid milks; milk products, including flavoured milks and milk drinks, dry milks, toppings, snack dips, spreads, weight control milk beverages, and other milk origin products; plant protein products, including the National Academy of Sciences/National Research Council “reconstituted vegetable protein” category, and meat, poultry, and fish substitutes, analogues, and extender products made from plant proteins; poultry products, including all poultry and poultry-containing dishes, salads, appetizers, frozen multicourse poultry meals, and sandwich ingredients prepared by commercial processing or using commercially processed poultry with home preparation; all commercially processed vegetables, vegetable dishes, frozen multicourse vegetable meals, and vegetable juices and blends; snack foods, including chips, pretzels, and other novelty snacks; soups, home-prepared, including meat, fish, poultry, vegetable, and combination home-prepared soups; soups and soup mixes, including commercially prepared meat, fish, poultry, vegetable, and combination soups and soup mixes.

Pet food is also included, such as dog, caw or cat foods.

A “Nutraceutical” as used herein relates to a compound that beneficially affects one or more functions of the body, so as to provide better health and wellness. Accordingly, such a nutritional supplement may be intended for the prevention and/or treatment of a disease or a disease-causing factor. Therefore, the term “nutritional composition” of the present invention can be used as a synonym for functional food or foods for particular nutritional purposes, or medical food. A nutritional composition is similar to that of a conventional food and consumed as part of a normal diet appearance. In a preferred embodiment, the nutraceutical is a Nutritional supplement.

As used herein, the term “nutraceutical supplement or nutraceutical product” refers to a product suitable for use in human beings or animals, comprising one or more natural products with therapeutic action which provide a health benefit or have been associated with disease prevention or reduction, and it includes dietary supplements presented in a non-food matrix (e.g., capsules, powder, etc.) of a concentrated natural bioactive product usually present (or not) in the foods and which, when taken in a dose higher than that existing in those foods, exerts a favorable effect on health which is greater than effect which the normal food may have. Therefore, the term “nutraceutical product” includes isolated or purified food products as well as additives or food supplements which are generally presented in dosage forms normally used orally, for example, capsules, tablets, sachets, drinkable phials, etc.; such products provide a physiological benefit or protection against diseases, generally against chronic diseases.

“Pharmaceutical product”, as used herein, relates to compositions and molecular entities that are physiologically tolerable. Preferably, the term “pharmaceutically acceptable” means it is approved by a regulatory agency of a state or federal government or is included in the U.S. Pharmacopoeia or other generally recognized pharmacopoeia for use in animals, and more particularly in humans.

“Cosmetic product”, as used herein refers to a composition suitable for use in personal hygiene of human beings or animals, or in order to enhance the natural beauty or change the body appearance without affecting the structure or functions of the human or animal body, comprising one or more products providing such effects. If desired, the cosmetic composition provided by the invention can contain, in addition to the composition of the invention, one or more cosmetics or cosmetic products, i.e., substances or mixtures intended to be placed in contact with the external parts of the human or animal body (e.g., epidermis, hair system, nails, lips, etc.) or with the teeth and the buccal mucosa, for the exclusive or main purpose of cleaning them, perfuming them, changing their appearance, protecting them, keeping them in good condition or correcting body odors. Illustrative examples of cosmetically acceptable vehicles include the products contained in the INCI (International Nomenclature of Cosmetic Ingredients) list. The composition of the present invention may be added to a wide variety of products for cosmetic application, including makeup, creams for cleansing, protecting, treating, or caring for the skin, in particular, the face, hands, and feet (e.g., day and night creams, makeup removal creams, foundation creams and sunscreens), liquid foundations, makeup removal lotions, protective or skin-care body lotions, sunscreen lotions, skin care lotions, gels, or foams, such as cleansing, sunscreen, and artificial tanning lotions, bath preparations, deodorant compositions, after-shave gels or lotions, depilatory creams, and compositions used for insect stings and against pain. The composition of the invention may take any of a wide variety of forms, and include, for example dressings, lotions, solutions, sprays, creams, gels, ointments, or the like.

The present invention is further illustrated by means of the following non-limiting examples:

### Example 1

### Goal of the Study

In the present study, the behavior of Clostridium botulinum (group II type B) during the process and the storage of cooked emulsified sausages stored vacuum-packed using different formulations (including a nitrite replacer) was evaluated.

### 1. Materials and methods

1.1. Spores of C. botulinum Preparation

A cocktail of three strains of C. botulinum type B non-proteolytic and toxin producer (BL7; 300.05 and 815.12 from Pasteur institute, France) were used.

After a culture step in BHI media 30° C. for 12 weeks under anaerobic conditions, spores were able to germinate, vegetative cells were able to grow and sporulation was possible.

After that, cells were exposed to a heated treatment at 60° C. for 20 min to destroy and vegetative cells and keep only the spores. Spores were centrifuged at 4500×g for 20 min, washed and put in a buffer solution.

### 1.2. Emulsified Cooked Sausage Model and Validation

The method was based on the following published procedure from Redondo-Solano et al. (2013) to study Clostridium perfringens risks in cooked ham. It has been extrapolated to a mix of minced pork meat. The meat mix was inoculated with the bacteria of interest, packed under vacuum packed in 50 g portions. Regarding the risks of C. botulinum biosafety reason, the embossing step was not able to be performed and the mixed meat have been stored under vacuum packed instead.

The emulsified cooked sausages ingredients were summarized in Table 1.

TABLE 1
Emulsified cooked sausages ingredients

| | Negative | | | Positive |
|---|---|---|---|---|
| Ingredients | control | Assay 1 | Assay 2 | control |
| Pork meat (kg) | 3.4 | 3.4 | 3.4 | 3.4 |
| Pork fat (kg) | 1.4 | 1.4 | 1.4 | 1.4 |
| Water + Ice (kg) | 1.2 | 1.2 | 1.2 | 1.2 |
| Salt NaCl (g) | 0 | 108 | 108 | 0 |
| White Pepper (g) | 0 | 12 | 12 | 12 |
| Garlic powder (g) | 0 | 6 | 6 | 6 |
| Nutmeg powder (g) | 0 | 3 | 3 | 3 |
| Coriander powder (g) | 0 | 6 | 6 | 6 |
| Dextrose (g) | 30 | 30 | 30 | 30 |
| Plasma (g) | 0 | 60 | 60 | 60 |
| Lactose (g) | 0 | 30 | 30 | 30 |
| Polyphosphates (g) | 0 | 0 | 0 | 0 |
| Sodium erythorbate (g) | 3 | 0 | 0 | 3 |
| Nitrite salt (g) | 0 | 0 | 0 | 108 |
| Extract blend 1 (g) | 0 | 18 | 0 | 0 |
| Extract blend 2 (g) | 0 | 0 | 18 | 0 |
| Total (kg) | 6.033 | 6.303 | 6.303 | 6.288 |

For each modality, pork meat and salt were ground firstly, then polyphosphates and natural extracts were added. In the next step, water and ice were added and mixed with the ground meat. To emulsify the product, pork fat was then added and ground. Finally, spices, sugars and plasma were incorporated in this emulsion.

The ground meat with C. botulinum spores at 102-103 spores per gram for the challenge test.

Homogenization was performed using a kitchen blender (Kenwood Major Titanium, Kenwood, Japon) speed 1 for 10 minutes.

After the emulsion process, the mix was not embossed due to safety reasons (inoculation of C. botulinum). Cooked emulsified sausages were then stored in vacuum packaging using equipment (INV 10, Intervac, France) and specific bags (Cryovac® CN 300, Sealed Air, France). Samples were prepared in triplicates.

Sausages were then cooked at 77° C. for 155 min and finally cooled down from 65° C. to 8° C. in 210 min, and from 8° C. to 4° C. in 60 min.

Sausages were stored under controlled temperatures during 40 days shelf life at 4° C. for 14 days followed by a break down in cold chain at 20° C. for 2 hours. After that, samples were kept at 8° C. for 26 days.

### 1.3. Extract Blends Composition

The extract's blend ensured the antioxidant and antimicrobial functions of nitrite, lactate and ascorbate/erythorbate.

Blend 1: buffered vinegar 68% (with a content of acetic acid of about 25%), acerola juice powder 9.4% (with a content of ascorbic acid of 34%), Rosemary extract 2.6% (59% carnosic acid).

Blend 2: Rosemary Flavor 13.4% (6% carnosic acid), acerola juice powder 9.4% (with a content of ascorbic acid of 34%).

### 1.4. Physico-Chemical Properties Evaluation

Water activity (aw) and pH were determined at day 0 just after the cooking and cooling down step, and at day 40 on samples from the same batches but without inoculation of C. botulinum spores.

For water activity, NF ISO 18787 (AFNOR, 2017) was followed using aw-meter from Aqualab 4TE, Meter Group, Allemagne. Measures were performed at 25° C.

For pH, ISO 2917: 1999 procedure was followed using Mettler-Toledo LoT406-M6-DXK-S7/25 (Urdorf, Suisse).

1.5. Enumeration of C. botulinum

After incubation of the suspension at 60° C. for 20 min, enumeration of C. botulinum vegetative cells and spores was performed on classical culture media (TS media 30° C. in anaerobic conditions for 24 to 48 h) on the day 0, 21, 30 and 40.

In parallel, lactic acid bacteria were enumerated on MRS agar after incubation at 30° C. for 24 h to 48 h under anaerobic conditions at day 0 after cooking step and day 40.

Total plate counts were evaluated on PCA after incubation at 30° C. for 24 h to 48 h under anaerobic conditions at day 0 before and after cooking step and day 40.

### 1.6. Detection of Botulinum Toxin by Bio-Assay

Botulinum toxin detection was performed by bio-assay on mice (5 samples for modalities) at day 21 and day 40.

Detection of toxin is performed injecting the knack suspension to mice. In order to be compliant with ethics regulation, when a mouse died due to toxin presence, the other mice were not injected, and the analysis was stopped.

### 2. Results

### 2.1. Physico-Chemical Properties Evaluation

Results of water activity and pH of emulsified cooked sausages are shown table 2.

TABLE 2
Water activity and pH of cooked emulsified sausage
model samples inoculated and stored 14 days at
4° C., 2 h at 20° C. and 26 days at 8° C.

| | aw | | pH | |
|---|---|---|---|---|
| | D 0 after cooking | D 40 | D 0 after cooking | D 40 |
| Blend 1 | 0.99 | 0.97 | 6.30 | 6.10 |
| | 0.98 | 0.99 | 6.25 | 6.20 |
| | 0.99 | 0.98 | 6.20 | 6.25 |
| Blend 2 | 0.99 | 0.99 | 6.15 | 6.15 |
| | 0.99 | 0.98 | 6.15 | 6.15 |
| | 0.98 | 0.98 | 6.15 | 6.20 |
| Positive control | 0.98 | 0.99 | 6.15 | 6.20 |
| with nitrite | 0.98 | 0.98 | 6.15 | 6.20 |
| | 0.98 | 0.98 | 6.15 | 6.10 |
| Negative control | 1.00 | 1.00 | 6.20 | 6.20 |
| without nitrite | 1.00 | 1.00 | 6.20 | 6.20 |
| | 1.00 | 1.00 | 6.20 | 6.20 |

Results were compliant with physicochemical properties commonly found in cooked emulsified sausages.

2.1 C. botulinum enumeration

Enumerations of C. botulinum by microbiological cultural approach are shown for assessing the level of inoculation and followed during the storage, respectively for both spores and vegetative cells in table 3 and for only spores (after heating treatment 20 min at 60° C.) in table 4.

TABLE 3
C. botulinum (spores + vegetative cells) inoculated in
cooked emulsified sausage model samples inoculated and stored
14 days at 4° C., 2 h at 20° C. and 26 days at 8° C. in CFU/g.

| | D 0 before | D 0 after | | | |
|---|---|---|---|---|---|
| | cooking | cooking | Day 21 | Day 30 | Day 40 |
| Blend 1 | 500 | 35 | <5 | 15 | <5 |
| | 750 | 25 | <5 | 20 | 5 |
| | 600 | 20 | <5 | 65 | 5 |
| Blend 2 | 850 | <5 | 5 | 5 | <5 |
| | 700 | <5 | 15 | <5 | 35 |
| | 1000 | 45 | 20 | <5 | 15 |
| Positive control | 250 | 5 | 15 | <5 | 5 |
| with nitrite | 450 | 20 | 10 | <5 | 5 |
| | 400 | 25 | 30 | 5 | <5 |
| Negative control | 1600 | <5 | <5 | <5 | 10 |
| without nitrite | 1200 | <5 | <5 | <5 | 20 |
| | 900 | <5 | <5 | <5 | 2000 |

Nitrite are known to inhibit the growth of vegetative cells of C. botulinum, and the germination of the spores. Similar to the positive control, meat model made using blend 1 and 2 have shown this inhibition compare to one sample without nitrite.

In order to check if the detection was vegetative cells or spores, a heated treatment is made to kill the vegetative cells. Enumeration is performed afterwards to detect the spore only. Results of level of spores only are shown table 4.

TABLE 4
C. botulinum (spores only) inoculated in cooked emulsified
sausage model samples inoculated and stored 14 days at
4° C., 2 h at 20° C. and 26 days at 8° C. in CFU/g

| | D 0 after cooking | Day 21 | Day 30 | Day 40 |
|---|---|---|---|---|
| Blend 1 | 10 | <5 | 5 | <5 |
| | <5 | <5 | <5 | <5 |
| | 10 | <5 | <5 | <5 |
| Blend 2 | <5 | <5 | <5 | <5 |
| | <5 | <5 | <5 | <5 |
| | 5 | <5 | <5 | <5 |
| Positive control | <5 | <5 | <5 | <5 |
| with nitrite | <5 | <5 | <5 | <5 |
| | 5 | <5 | <5 | <5 |
| Negative control | 5 | <5 | <5 | <5 |
| without nitrite | <5 | <5 | <5 | <5 |
| | 5 | <5 | <5 | <5 |

Similar than controls, they were below detection level of C. botulinum spores at the end of the shelf life in meat model with blend 1 and 2.

Level of lactic acid bacteria were also performed and shown table 5. This results it is shown as control of the potential competition of the inoculated bacteria.

TABLE 5
Endogenous lactic acid bacteria in cooked emulsified
sausage model samples inoculated and stored 14 days
at 4° C., 2 h at 20° C. and 26 days at 8° C. in CFU/g

Lactic acid bacteria

| | D 0 after cooking | Day 40 |
|---|---|---|
| Blend 1 | 5 | <5 |
| | <5 | <5 |
| | <5 | <5 |
| Blend 2 | <5 | <5 |
| | <5 | <5 |
| | <5 | <5 |
| Positive control | <5 | <5 |
| with nitrite | <5 | <5 |
| | <5 | <5 |
| Negative control | <5 | <5 |
| without nitrite | <5 | <5 |
| | <5 | <5 |

### 2.2. Toxin Detection

In order to detect the production of toxin, sample of cooked emulsified sausage model samples inoculated were put in suspension to be inoculated to mice1. Detection of toxin was done at day 21 and day 40 and results are shown Table 6.

TABLE 6
Detection of toxines of C. botulinum on mice bio-assays
in 5 cooked emulsified sausage model samples inoculated and
stored 14 days at 4° C., 2 h at 20° C. and 26 days at 8° C.

| | D 0 after cooking | Day 21 | Day 30 | Day 40 |
|---|---|---|---|---|
| Blend 1 | ND | 0/5 | ND | 0/5 |
| Blend 2 | ND | 0/5 | ND | 1/5* |
| Positive control | ND | 0/5 | ND | 0/5 |
| with nitrite | | | | |
| Negative control | 0/5 | 0/5 | ND | 3/5** |
| without nitrite | | | | |

*1 positive sample
**3 positive samples
ND non detected

In the table 6, positive sample means that at least one mouse is dead after meat suspension injection. When 0/5 result occur that mean, mouse injected with the meat suspension is alive, no toxin production is detected.

It is known in the literature (Majou D et al.) that the use of nitrite can inhibit the production of C. botulinum toxin and put the cured meat product at risk for consumer. The results in the negative control without the use of nitrite is confirming this statement. Toxins were produce by C. botulinum at the end of the shelf life when no preservative agent were used. We demonstrate that using the blend 1 solution (buffered vinegar, acerola, rosemary extract) or positive control (nitrites) we can inhibit the production of toxin, and keep the meat product safe for the consumer.

### Example 2

### Extracts Preparation

Rosemary Acetone extract.

Whole natural, i.e., oil-containing, rosemary leaves (100 Kg) were extracted with 220 L of room temperature acetone for 36 hours and concentrated under a vacuum of 50-350 mm. Hg. to 120 L. The extract contained 2.6 kg of carnosic acid. Approximately 16 L of aqueous sodium carbonate containing 2.5 equivalents of base per equivalent of carnosic acid was added to the extract mixture slowly with stirring. Then 600 L of DI water containing 300 grams of EDTA was added into the basic extract, maintaining a pH of 8.7-90 (slashed zero) A dark green precipitate formed and was removed by centrifugation and decantation. The 740 L of filtrate was then distilled under vacuum at approximately 700 (degree) and between 9 and 10 psi, removing 100 L of acetone and 190 L of water. The resulting solution was acidified with 10% phosphoric acid to a pH of 2.2. A cream-colored precipitate was formed. The precipitate was separated from the filtrate by centrifugation and decantation and then air dried. The final product (2.75 Kg) had a carnosic acid purity of 71% by weight and had the following levels of monoterpenes based on carnosic acid content: 5.6 ppm myrcene, 5.6 ppm alpha-terpine, 12.6 ppm 1, 8 cineole, 7 ppm camphor and 1.4 ppm endo-borneol. The absorptivity (1 cm cell) at 415 nm of the product dissolved in denatured alcohol was 0.4 per 1 mg carnosic acid/mL solution. The product had a low level of flavor and odor

Acetone may be replaced by ethanol and any other organic solvent. Rosemary ethanol extracts were done as described before but changing the solvent.

Sage and thyme extracts were done using similar extraction method as for rosemary. Crude or purified or any other extracts involving mixing Lamiaceae plant material, wherein Lamiaceae means any species from Lamiaceae family, including plant of the Lamiaceae family, preferably rosemary, sage, oregano, thyme, mints, and the following genera: Salvia, Rosmarinus, Lepechinia, Origanum, Thymus, Ocimum, Hyssopus, Zataria, and mixtures thereof, with solvent, and comprising phenolic diterpene(s), including carnosic acid are concerned by this application.

Inhibition screening of Clostridium botulinum cells; read out with qPCR

### Growth Medium TPGY Medium

For 1 liter: 50 gr Tryptone (Oxoid LP0042), 5 gr Bacterial Peptone (Oxoid LP0037), 4 gr Glucose (Sigma G8270), 20 gr Yeast extract (Oxoid LP0021), 1 gr Cysteine-HCl (Biochemical 370555X), Filter sterilization with 0.22 um filter (pH 6.8-7.0). For screening: add 4N HCl to medium till pH 5.8 and sterilize medium with 0.22 um filter.

Inoculum preparation for Clostridium botulinum vegetative cells Inoculum preparation for Clostridium botulinum vegetative cells in anaerobic cabinet
Proteolytic Clostridium botulinum Type A Strains NCTC 7272
Nonproteolytic Clostridium botulinum Type E Strains NCTC 8266 Transfer 2 μL C. botulinum spores (10e7-8 CFU/mL) in 10 mL TPGY medium pH 6.8-7.0. Incubate at 30° C. overnight anaerobic. Make 10⁴ cell dilution from overnight culture in fresh 20 mL TPGY medium pH 5.8 and incubate at 30° C. anaerobic.

### Screen Set Up

Dilute C. botulinum spores or vegetative cells TPGY medium pH5.8 (concentration approx. 10⁴ CFU/ml). Add to 2 ml 96 wells plate (Axygen, P-DW-20-C): Per individual well −250 μL 2× concentrated component in TPGY medium pH5.8.-250 μL C. botulinum spores or vegetative cells TPGY medium pH5.8 (concentration approx. 10e4 CFU/ml). Cover 96 wells plate with breathable seal. ⋅ Incubate for C. botulinum type A strain at 30° C., 48 hours and for C. botulinum type E 10-14 days at 10° C. ⋅ Transfer 100 μL sample from exposed culture to 2 mL 96 wells plate for DNA isolation. ⋅ For long time storage, collect samples in −20° C. freezer.

### DNA Isolation

DNA isolation from exposed C. botulinum cells DNA extraction was performed according to Ladirat et al., 2014 (Br J Nutr. 2014 Aug. 28; 112(4):536-46. doi: 10.1017/S0007114514001135) with the exception that instead of fecal material, the C. botulinum cultures were used as starting material.

Quantitative PCR Proteolytic and Non-Proteolytic C. botulinum

Quantitative PCR for the detection of genetic material of proteolytic or non proteolytic C. botulinum was performed according to the protocol described in Oliveira et al., 2014 (Poult Sci. 2014 April; 93(4):818-29. doi: 10.3382/ps.201303409). The utilized primers and probes are described in Table 7.

TABLE 7
C. botulinum qPCR oligo's; Target gene is 16S (proteolytic, including
type A) and 23S (nonproteolytic, including type E) ribosomal RNA gene
proteolytic C. botulinum (incl. type A)

| | |
|---|---|
| Cbot-23F | CACGCCGTAAACGATGGATA |
| Cbot-101R | GGGGGGATACTTATTGTGTTAACTG |
| Cbot-54Probe | FAM-GGGTATCAACTCCCC-MGB |

non-proteolytic C. botulinum (incl. type E)

| | |
|---|---|
| 23S-C.bot-gr2-F | GATTTATCTTTGGGGTTGCGGA |
| 23S-C.bot-gr2 probe | VIC-AACATTAACGAGAAATTATG-MGB |
| 23S-C.bot-gr2-R | GTCCAACTTTCCAGTTGTGTTCG |

### 2. Results

qPCR analyses data were used to evaluate the efficacy of plant extracts on inhibition of microbial growth.

Non proteolytic and proteolytic bacterial Clostridium botulinum strains were used. The tests were conducted on vegetative cells and on corresponding spores. qPCR results were expressed in Ct (Cycle threshold values).

Thus low Ct corresponds to the high amount in DNA and high Ct corresponds to the low amount in DNA.

dbt is the difference between Ct value of control (no inhibitor) and Ct value of plant sample (inhibitor).

When dSt is high, this means that the inhibition is high and when it is low, the inhibition is low. Maximal growth inhibition is equivalent to the amount of outgrowth in the control (no inhibitor). Results were kept when at leas 50% of inhibition of C. botulinum cells was observed.

### 2.1. Lamiaceae

TABLE 8
Effect of different species of Lamiaceae extracts against Clostridium. Concentration
of blend (in ppm) when at least 50% inhibition of C botulinum.

| | | Proteolytic | | Non Proteolytic | |
|---|---|---|---|---|---|
| | | Clostridium | Proteolytic | Clostridium | Non Proteolytic |
| | | botulinum | Clostridium | botulinum | Clostridium |
| | | Type A Strains | botulinum | Type E Strains | botulinum |
| | | NCTC 7272 | Type A Strains | NCTC 8266 | Type E Strains |
| | | Vegetative | NCTC 7272 | Vegetative | NCTC 8266 |
| | | cells inhibition | Spores inhibition | cells inhibition | Spores inhibition |
| Rosemary | Acetone extraction - | 310 | 310 | 80 | 310 |
| carnosic | Carnosic acid 0.52% | | | | |
| | Acetone extraction - | 160 | 160 | 80 | 80 |
| | Carnosic acid 1.14% | | | | |
| | Acetone extraction - | 80 | 310 | 80 | 310 |
| | Carnosic acid 57.36% | | | | |
| | Ethanol extraction - | 80 | 310 | 80 | 310 |
| | Carnosic acid 4.16% | | | | |
| | Ethanol extraction - | 78 | 78 | 78 | 78 |
| | Carnosic acid 6% | | | | |
| | Ursolic acid 35% | 160 | 310 | 80 | 310 |
| Sage | salvia officinalis acetone | 78 | 78 | 78 | 78 |
| | (CC6/160-01) CA 18.3%/ | | | | |
| | carnosol 1.8%/RA 0.8% | | | | |
| | salvia officinalis acetone | 620 | 620 | 620 | 620 |
| | (AA7/090-03) CA 17.7%/ | | | | |
| | carnosol 1.9%/RA 1.3% | | | | |
| | salvia officinalis ethanol | 78 | 78 | 78 | 78 |
| | (AA7/090-03) CA 13.2%/ | | | | |
| | carnosol 1.5%/RA 2.8% | | | | |
| | salvia officinalis ethanol | 620 | 620 | 620 | 620 |
| | (CC6/160-01) CA 14.7%/ | | | | |
| | carnosol 1.4%/RA 5.2% | | | | |
| | Salvia officinalis ethanol: | 80 | 80 | 80 | 80 |
| | CA 13.2%/carnosol 1.5/ | | | | |
| | RA 2.8 | | | | |
| | Salvia officinalis acetone: | 80 | 80 | 80 | 80 |
| | CA 17,7%/carnosol 1.9/ | | | | |
| | RA 1.3 | | | | |
| | Salvia apiana ethanol | 620 | 620 | 312 | 312 |
| | ethanol CA 8.3%/ | | | | |
| | carnosol 1.1/RA 2.4 | | | | |
| | Salvia apiana acetone - | 156 | 156 | 78 | 78 |
| | CA 5.69% | | | | |
| Thyme | Thymus vulgaris ethanol | 625 | 312 | 312 | 156 |
| | CA 0.6%/carnosol 0.0%/ | | | | |
| | RA 6.0% | | | | |
| | Thymus capitatus ethanol | 625 | 625 | 312 | 312 |
| | CA 0%/carnosol 4.2%/ | | | | |
| | RA 0.7% | | | | |
| | Thyme cleaned (zataria | 625 | 625 | 310 | 156 |
| | multiflora boiss) ethanol | | | | |
| | CA 0%/carnosol 3.9%/ | | | | |
| | RA 0.4% | | | | |

### 2.2: Rosemary and Acerola Blends.

TABLE 9
Concentration of blend (in ppm) when at least 50% inhibition of C botulinum.

| | | Proteolytic | | Non Proteolytic | |
|---|---|---|---|---|---|
| | | Clostridium | Proteolytic | Clostridium | Non Proteolytic |
| | | botulinum | Clostridium | botulinum | Clostridium |
| | | Type A Strains | botulinum | Type E Strains | botulinum |
| | | NCTC 7272 | Type A Strains | NCTC 8266 | Type E Strains |
| | | Vegetative | NCTC 7272 | Vegetative | NCTC 8266 |
| | | cells inhibition | Spores inhibition | cells inhibition | Spores inhibition |
| Rosemary | Carnosic acid 0.52% | 310 | 310 | 80 | 310 |
| extract | | | | | |
| Acerola | Ascorbic acid 2.67% | n/e | n/e | n/e | n/e |
| BLend RA | Carnosic acid 0.52% + | 160 | 310 | 80 | 310 |
| Rosemary + | Ascorbic acid 2.67% | | | | |
| Acerola | | | | | |

n/e: not efficient.

### Example 3. Cooked Ham

In the present study, the behavior of Clostridium botulinum (group II type B) during the process and the storage of cooked ham stored vacuum-packed using different formulations (including a nitrite replacer) was evaluated.

Materials and methods are similar to example 1 with the same C. botulinum cell preparation of three strains of C. botulinum type B non-proteolytic and toxin producer (BL7; 300.05 and 815.12 from Pasteur institute, France).

The method was based on the following published procedure from Redondo-Solano et al. (2013) to study Clostridium perfringens risks in cooked ham.

The cooked ham brine ingredients were summarized in Table 10.

TABLE 10
Cooked ham brine ingredients

| | Dosage | | | | |
|---|---|---|---|---|---|
| | in final | Nitrite | Negative | Formula- | Formula- |
| | product | control - | control - | tion A - | tion B - |
| Ingredients | g/kg | Brine (%) | Brine (%) | Brine (%) | Brine (%) |
| Salt | 18 | | | 19.8 | 19.8 |
| Sodium nitrite | 18 | 19.8 | | | |
| (eq to | | | | | |
| 108 ppm) | | | | | |
| Erythorbate | 0.5 | 0.55 | 0.55 | 0.55 | 0.55 |
| Dextrose | 5 | 5.5 | 5.5 | 5.5 | 5.5 |
| Blend A | 10 | | | 11 | |
| Blend B | 10 | | | | 11 |
| Water | | 74.15 | 93.95 | 51.60 | 63.15 |

| | | | | |
|---|---|---|---|---|
| Total | 100 | 100 | 100 | 100 |

For each modality, pork meat and salt+combination of extracts were ground in an incorporation of 10% of brine in meat.

The meat were inoculated with C. botulinum spores at 10\hat{ }2-10\hat{ }3 spores per gram for the challenge test. Homogenization was performed using a kitchen blender (Kenwood Major Titanium, Kenwood, Japon) speed 1 for 10 minutes.

Cooking step to reach 64° C. in meat in 793 min were followed by a cooling step at 4° C. in 565 min. Pasteurization value is of 66.5 for a z=10° C. and a reference temperature at 70° C.

Samples were prepared in triplicates.

Cooked ham were stored under controlled temperatures during 40 days shelf life at 4° C. for 10 days followed by 30 days at 8° C.

### Extract Blends Composition

The extract's blend ensured the antioxidant and antimicrobial functions of nitrite, lactate and ascorbate/erythorbate.

Blend A: acidic vinegar 13.75% (with a content of acetic acid of 10%), acerola juice powder 3.4% (with a content of ascorbic acid of 34%), Sage extract (35.59% carnosic acid and carnosol) 1.25%

Blend B: Sage extract (35.59% carnosic acid and carnosol) 1.88%, acerola juice powder 6.8% (with a content of ascorbic acid of 34%).

### Physico-Chemical Properties Evaluation

Results of water activity and pH of emulsified cooked ham are shown table 11.

TABLE 11
Water activity and pH of cooked ham model samples inoculated and
stored 10 days at 4° C. and 30 days at 8° C.

| | aw | | pH | |
|---|---|---|---|---|
| | D 0 after cooking | D 40 | D 0 after cooking | D 40 |
| Blend A | 0.98 | 0.98 | 6.00 | 5.95 |
| | 0.98 | 0.98 | 5.90 | 5.95 |
| | 0.98 | 0.98 | 5.95 | 5.95 |
| Blend B | 0.98 | 0.98 | 6.05 | 6.00 |
| | 0.97 | 0.98 | 6.05 | 6.00 |
| | 0.98 | 0.98 | 6.10 | 6.00 |
| Positive control | 0.98 | 0.98 | 6.00 | 6.00 |
| with nitrite | 0.98 | 0.98 | 6.00 | 6.00 |
| | 0.98 | 0.98 | 5.95 | 6.00 |
| Negative control | 1.00 | 0.99 | 6.05 | 5.70 |
| without nitrite | 0.99 | 0.99 | 6.05 | 6.05 |
| | 0.99 | 1.00 | 6.05 | 6.05 |

Results were compliant with physicochemical properties commonly found in cooked emulsified sausages.

C. botulinum Enumeration

Enumerations of C. botulinum by microbiological cultural approach are shown for assessing the level of inoculation and followed during the storage, respectively for both spores and vegetative cells in table 12.

TABLE 12
C. botulinum (spores + vegetative cells) inoculated
in cooked ham model samples inoculated and stored
10 days at 4° C. and 30 days at 8° C. in CFU/g.

| | D 0 before | D 0 after | | |
|---|---|---|---|---|
| | cooking | cooking | Day 21 | Day 40 |
| Blend A | 1.1E+03 | 4.5E+01 | 4.5E+01 | 1.0E+01 |
| | 1.3E+03 | 6.0E+01 | 2.5E+01 | 5.0E+00 |
| | 1.1E+03 | 3.0E+01 | 1.0E+01 | <5.0E+00 |
| Blend B | 9.5E+02 | 1.5E+01 | 1.5E+01 | 1.5E+01 |
| | 7.5E+02 | 3.5E+01 | 1.0E+01 | 1.5E+01 |
| | 1.0E+03 | 2.5E+01 | 4.0E+01 | 4.5E+01 |
| Positive control | 4.5E+02 | 2.5E+01 | 5.0E+00 | <5.0E+00 |
| with nitrite | 7.0E+02 | 3.5E+01 | <5.0E+00 | <5.0E+00 |
| | 4.0E+02 | 5.0E+00 | <5.0E+00 | <5.0E+00 |
| Negative control | 3.0E+02 | <5.0E+00 | <5.0E+00 | 1.0E02 |
| without nitrite | 3.0E+02 | 1.5E+01 | <5.0E+00 | <5.0E+00 |
| | 1.0E+02 | 5.0E+00 | <5.0E+00 | <5.0E+00 |

Nitrite are known to inhibit the growth of vegetative cells of C. botulinum, and the germination of the spores. Similar to the positive control, meat model made using blend A and B have shown this inhibition compare to one sample without nitrite.

Similar than controls, they were below detection level of C. botulinum spores at the end of the shelf life in meat model with blend A and B.

Level of lactic acid bacteria were also performed and were all below 5 CFU/g. This results were performed as control of the potential competition of the inoculated bacteria.

### Toxin Detection

In order to detect the production of toxin, sample of cooked ham model samples inoculated were put in suspension to be inoculated to mice. Detection of toxin was done at day 20 and day 40 and results are shown Table 13.

TABLE 13
Detection of toxins of C. botulinum on mice bio-
assays in 5 cooked ham model samples inoculated
and stored 10 days at 4° C. and 30 days at 8° C.

| | Day 20 | Day 40 |
|---|---|---|
| Blend A | 0/5 | 0/5 |
| Blend B | 0/5 | 1/5* |
| Positive control with nitrite | 0/5 | 0/5 |
| Negative control without nitrite | 0/5 | 1/5* |

*1 positive sample

In the table 13, positive sample means that at least one mouse is dead after meat suspension injection. When 0/5 result occur that mean, mouse injected with the meat suspension is alive, no toxin production is detected.

### REFERENCES

Sharma, Shashi & Whiting, Richard. (2005). Methods for Detection of Clostridium botulinum Toxin in Foods. Journal of food protection. 68. 1256-63. 10.4315/0362-028X-68.6.1256.
Majou D, Christieans S. Mechanisms of the bactericidal effects of nitrate and nitrite in cured meats. Meat Sci. 2018 November; 145:273-284. doi: 10.1016/j.meatsci.2018.06.013. Epub 2018 Jul 10. PMID: 30005374

1. A method of preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of Clostridium toxins in a product, comprising adding to the product at least a Lamiaceae extract and/or ascorbic acid and/or acetic acid and any mixtures thereof.

2. The method according to claim 1, wherein the at least one Lamiaceae extract and/or ascorbic acid and/or acetic acid is added to the product in the form of a premixed anti-botulinum composition or added separately to the product.

3. The method according to claim 1, wherein the Lamiaceae is selected from the genus Salvia, Rosmarinus, Lepechinia, Oreganum, Thymus, Hyssopus and any mixtures thereof.

4. The method according to claim 1, wherein the Lamiaceae extract comprises at least one phenolic diterpene.

5. A method of preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of Clostridium toxins in a product, comprising adding to the product at least one phenolic diterpene and/or ascorbic acid and/or acetic acid and/or ursolic acid and any combinations thereof.

6. The method according to claim 5, wherein the at least one phenolic diterpene and/or ascorbic acid and/or acetic acid and/or ursolic acid is added to the product in the form of a premixed anti-botulinum composition or added separately to the product.

7. The method according to claim 5, wherein the phenolic diterpene is obtained from a Lamiaceae plant.

8. The method according to claim 7, wherein the Lamiaceae plant is selected from the genus Salvia, Rosmarinus, Lepechinia, Oreganum, Thymus, Hyssopus and any mixtures thereof.

9. (canceled)

10. The method according to claim 4, wherein the at least one phenolic diterpene is selected from carnosic acid and/or carnosol.

11. The method according to claim 4, wherein the concentration of the at least one phenolic diterpene in the final product is from about 5 ppm, 10 ppm, 12 ppm, 15 ppm, 20 ppm, 30 ppm, 40 ppm, 50 ppm, 60 ppm, 70 ppm, 80 ppm, 90 ppm 100 ppm, to about 6%, 5%, 4%, 4%, 3%, 2%, 1%, 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm or 200 ppm w/w.

12. The method according to claim 1, wherein the ascorbic acid is from a natural source, synthetic origin or from fermentation.

13. The method according to claim 1, wherein the acetic acid is selected form a concentrated or not concentrated vinegar, buffered vinegar, non-buffered vinegar, or any mixtures thereof.

14. The method according to claim 1, wherein the Lamiaceae extract, ascorbic acid and acetic acid are formulated together as a composition.

15. The method according to claim 1, wherein the Lamiaceae extract is a rosemary extract comprising phenolic diterpenes, the ascorbic acid is an acerola extract and the acetic acid is buffered and/or non-buffered vinegar.

16. The method according to claim 15, wherein the ratio between acetic acid, ascorbic acid and the at least one phenolic diterpene is from 95:3:2 to 20:60:20.

17. The method according to claim 1, wherein the concentration of the ascorbic acid in the final product is from about 12 ppm, 15 ppm, 20 ppm, 30 ppm, 40 ppm, 50 ppm, 60 ppm 70 ppm, 80 ppm, 90 ppm, 100 ppm, 150 ppm to about 6%, 5%, 4%, 4%, 3%, 2%, 1%, 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm or 200 ppm w/w.

18. The method according to claim 1, wherein the concentration of the acetic acid in the final product is from about 12 ppm, 15 ppm, 20 ppm, 30 ppm, 40 ppm, 50 ppm, 60 ppm, 70 ppm, 80 ppm, 90 ppm, 100 ppm, to about 6%, 5%, 4%, 4%, 3%, 2%, 1%, 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm or 200 ppm.

19. The method according to claim 1, wherein the at least one phenolic diterpene is added to the product to obtain a concentration in the final product of from 5 ppm to 1% of the at least one phenolic diterpene in respect to the final weight of the product, ascorbic acid is added to the product to provide a final concentration in the product of from 10 ppm to 1% in respect to the final weight of the product, and acetic acid is added to the product to provide a final concentration in the product of from 10 ppm to 1% in respect to the final weight of the product.

20. (canceled)

21. The method according to claim 1, wherein the product is a food or a beverage.

22. The method according to claim 1, further comprising a step of packaging said product, a sterilization step and/or a cooking step.

23. The method according to claim 1, wherein the final product is essentially free of nitrite and nitrate.

24. The method according to claim 1, wherein the Clostridium is selected from C. difficile, C. botulinum of anyone or more of phenotypic groups I to IV and serotypes A, B, C, D, E, F and/or G, C. sporogenes, C. perfringens of anyone or more of Type A, Type B, Type C, Type D and Type E, B. cereus, and B. subtilis.

25. (canceled)

26. (canceled)

27. (canceled)

28. (canceled)
